(19) United States
(12) Patent Application Publication
(10) Pub. No.: US 2022/0285770 A1
(43) Pub. Date: Sep. 8, 2022

(54) BATTERY MODULE AND METHOD OF MANUFACTURING SAME

(71) Applicants: HYUNDAI MOTOR COMPANY, Seoul (KR); KIA CORPORATION, Seoul (KR)

(72) Inventors: Kyung Mo KIM, Ansan-si (KR); Jae Ho CHUN, Busan (KR); Tae Hyuck KIM, Asan-si (KR); Hyun Jun YOON, Goyang-si (KR); Ho Kyun Ju, Suwon-si (KR)

(73) Assignees: HYUNDAI MOTOR COMPANY, Seoul (KR); KIA CORPORATION, Seoul (KR)

(21) Appl. No.: 17/410,178

(22) Filed: Aug. 24, 2021

(30) Foreign Application Priority Data
Mar. 8, 2021 (KR) 10-2021-0030368

(51) Int. Cl. H01M 50/209; H01M 10/04; H01M 50/271; H01M 50/262; H01M 50/507; H01M 50/503; H01M 50/516; H01M 50/249; B60L 50/64

(52) U.S. Cl. CPC H01M 50/209; H01M 10/0481; H01M 50/271; H01M 50/262; H01M 50/507; H01M 50/503; H01M 50/516; H01M 50/249; B60L 50/64; H01M 2220/20

(57) ABSTRACT

A battery module includes: a battery cell stack including a plurality of battery cells stacked on each other in a first direction; a pair of cell covers which is in surface contact with both side surfaces of the battery cell stack; a housing which covers side surfaces of the pair of cell covers in the first direction and top surfaces of the battery cell stack. In particular, a bottom side of the housing is open.

### CROSS REFERENCE TO RELATED APPLICATION

This application claims priority to and the benefit of Korean Patent Application No. 10-2021-0030368, filed on Mar. 8, 2021, the entire contents of which are incorporated herein by reference.

### FIELD

The present disclosure generally relates to a battery module used in vehicles and a method of manufacturing the same.

### BACKGROUND

The statements in this section merely provide background information related to the present disclosure and may not constitute prior art.

Recently, according to the global trend of reducing carbon dioxide emissions, demand is significantly increasing for electric vehicles that generate driving power by operating a motor using electric energy stored in an energy storage device, such as a battery, in place of typical internal combustion engine vehicles that generate driving power by the combustion of fossil fuel.

The performance of an electric vehicle significantly depends on the capacity and performance of a battery corresponding to an energy storage device that stores electric energy to be supplied to a drive motor.

A vehicle battery that stores electric energy to be supplied to the motor to generate drive power for a vehicle must have superior electrical properties, such as superior charge and discharge performance and extended use life, as well as high-level mechanical performance providing robustness to hostile vehicle driving conditions, such as high temperature and high vibration.

In addition, it may be advantageous for vehicle manufacturers to configure battery hardware in the form of modules having standardized sizes or capacities so as to be consistently applied to a variety of types of vehicles.

In battery modules of the related art, covers are provided for six surfaces of a battery cell stack (i.e. a stack of battery cells), respectively. Thus, a process is more complicated due to the operation of integrally coupling the covers, thereby disadvantageously increasing costs.

The foregoing is intended merely to aid in the understanding of the background of the present disclosure, and is not intended to mean that the present disclosure falls within the purview of the related art that is already known to those skilled in the art.

### SUMMARY

The present disclosure proposes a battery module having standardized sizes and capacities so as to be consistently applied to a variety of types of vehicles.

In one aspect of the present disclosure, a battery module includes: a battery cell stack including a plurality of battery cells stacked on each other in a first direction; a pair of cell covers in surface contact with both side surfaces of the battery cell stack; and a housing covering side surfaces of the cell covers in the first direction and top surfaces of the battery cell stack and the cell covers, with a bottom side of the housing being open.

The housing may include a connector on the bottom side thereof, the connectors connecting bottom portions of both side walls of the housing in the first direction.

The housing may include an insulating material applied to a bottom surface of a top wall and a top surface of the connector.

Each of the cell covers may include a guide protruding from an outer surface thereof and extending in a longitudinal direction, each of the both side walls of the housing may have a groove extending in the longitudinal direction and conforming to the guide, and the guide may be inserted into the groove to guide sliding of the battery cell stack and the cell cover.

The battery module may further include a fixing unit provided on the cell covers or the housing to prevent the battery cell stack and the cell covers from moving within the housing.

The fixing unit may include first protruding portions each protruding outward from one end of each of the cell covers and first recesses indented in the side walls of the housing, at positions corresponding to the first protruding portions. The battery cell stack and the cell covers may be fixed to the housing in response to the first protruding portions being fitted into the first recesses.

The housing may have a through-hole provided in a top wall thereof.

The cell covers may be made from an insulating material and have a higher level of strength than the battery cells.

The battery module may further include a pair of housing covers fastened to both side surfaces of the housing to cover both ends of the housing, with the both ends of the housing facing in a second direction perpendicular to the first direction.

The battery module may further include a pair of bus bar assemblies located on both ends of the battery cell stack in a second direction perpendicular to the first direction to join electrodes of the plurality of battery cells.

Second protrusions may protrude outward from both ends of each of the bus bar assemblies, with the both ends of the bus bar assemblies being in the first direction. Second recesses may be indented in both side walls of the housing, at positions corresponding to the second protrusions. The second protrusions may be fitted into the second recesses, thereby fixing the bus bar assemblies.

Each of the bus bar assemblies may include a bus bar having a plurality of slits. The electrodes of the plurality of battery cells may be joined to the bus bar, with portions of the electrodes that have passed through the slits being bent.

Recesses may be formed in a top wall of the housing, indented in the second direction perpendicular to the first direction. When the electrodes of the plurality of battery cells are joined to the bus bar, stopper jigs may be inserted through the recesses to support the bus bar.

According to another aspect of the present disclosure, a method of manufacturing the battery module may include: stacking the plurality of battery cells in the first direction and stacking the cell covers on the both side surfaces of the battery cell stack; pressing the battery cell stack and the cell covers in the first direction using a plurality of pressing jigs through both side surfaces of the cell covers facing in the first direction, wherein the pressing jigs are disposed in a second direction perpendicular to the first direction while facing each other in the first direction; and sliding and inserting the battery cell stack and the cell covers into the housing while sequentially stopping the pressing of the pressing jigs adjacent to the housing from among the plurality of pressing jigs.

The method of manufacturing the battery module may further include: after inserting the battery cell stack and the cell covers into the housing, aligning leads of the plurality of battery cells using an alignment guide by inserting portions of the alignment guide between the plurality of battery cells; and inserting the bus bar assemblies to join the electrodes of the plurality of battery cells in a position in which the plurality of battery cells is aligned.

The method of manufacturing the battery module may further include: after inserting the bus bar assemblies, inserting stopper jigs to fix the bus bar assemblies; and welding the electrodes of the battery cells to the bus bar assemblies in a position in which the stopper jigs are inserted.

The method of manufacturing the battery module may further include, after welding the electrodes of the battery cells, coupling the housing covers to the housing such that both ends of the housing facing in the second direction perpendicular to the first direction are covered with the housing covers.

In the battery module according to the present disclosure, the battery cell stack and the cell covers covering the outer side surfaces of the battery cell stack are inserted into the housing, the bus bar assemblies are coupled to the battery cell stack, and the housing covers are coupled to the housing to cover both ends of the housing, with the both ends facing in the first direction. Accordingly, the number of components may be reduced compared to the related-art battery module in which the cell covers for covering the six surfaces of the battery cell stack are separately manufactured and then are coupled together, thereby reducing costs. In addition, since the operation of welding the plurality of cell covers is omitted, the manufacturing process may be advantageously simplified.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is an exploded perspective view illustrating a battery module according to one form of the present disclosure;

FIG. 2 is a bottom perspective view of the housing according to another form of the present disclosure;

FIG. 3 is a view illustrating the housing, as well as the battery cell stack and the pair of cell covers being inserted into the housing, according to one form of the present disclosure;

FIG. 4 is a view illustrating first protruding portions and first recesses, into the first protruding portions are being fitted, according to one form of the present disclosure;

FIG. 5 is a view illustrating the battery cells aligned and the bus bar assemblies being coupled to the battery cells according to another form of the present disclosure;

FIG. 6 is a view illustrating the housing, as well as the battery cell stack and the cell covers received in the housing, according to another form of the present disclosure;

FIG. 7 is a view illustrating the insertion of the stopper jigs supporting the bus bar assemblies when the bus bar assemblies are joined according to another form of the present disclosure;

FIG. 8 is a perspective view illustrating the assembled battery module according to another form of the present disclosure;

FIG. 9 is a plan view illustrating a process of manufacturing a battery module by sliding and coupling the battery cell stack and the cell covers to the housing according to one form of the present disclosure;

FIG. 10 is a flowchart of the method of manufacturing a battery module according to another form of the present disclosure; and

FIG. 11 is a view illustrating a variety of implementations of the fixing unit according to some forms of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Specific structural and functional descriptions of forms of the present disclosure disclosed herein are only for illustrative purposes of the forms of the present disclosure. The present disclosure may be embodied in many different forms without departing from the spirit and significant characteristics of the present disclosure. Therefore, the forms of the present disclosure are disclosed only for illustrative purposes and should not be construed as limiting the present disclosure.

Reference will now be made in detail to various forms of the present disclosure, specific examples of which are illustrated in the accompanying drawings and described below, since the forms of the present disclosure can be variously modified in many different forms. While the present disclosure will be described in conjunction with exemplary forms thereof, it is to be understood that the present description is not intended to limit the present disclosure to those exemplary forms. On the contrary, the present disclosure is intended to cover not only the exemplary forms, but also various alternatives, modifications, equivalents and other forms that may be included within the spirit and scope of the present disclosure.

It will be understood that, although the terms “first”, “second”, etc. may be used herein to describe various elements, these elements should not be limited by these terms. These terms are only used to distinguish one element from another element. For instance, a first element discussed below could be termed a second element without departing from the teachings of the present disclosure. Similarly, the second element could also be termed the first element.

It will be understood that when an element is referred to as being “coupled” or “connected” to another element, it can be directly coupled or connected to the other element or intervening elements may be present therebetween. In contrast, it should be understood that when an element is referred to as being “directly coupled” or “directly connected” to another element, there are no intervening elements present. Other expressions that explain the relationship between elements, such as “between”, “directly between”, “adjacent to”, or “directly adjacent to” should be construed in the same way.

The terminology used herein is for the purpose of describing particular forms only and is not intended to be limiting. As used herein, the singular forms “a”, “an”, and “the” are intended to include the plural forms as well, unless the context clearly indicates otherwise. It will be further understood that the terms “comprise”, “include”, “have”, etc. when used in this specification, specify the presence of stated features, integers, steps, operations, elements, components, and/or combinations thereof but do not preclude the presence or addition of one or more other features, integers, steps, operations, elements, components, and/or combinations thereof.

Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, exemplary forms of the present disclosure will be described in detail with reference to the accompanying drawings. Throughout the drawings, the same reference numerals will refer to the same or like parts.

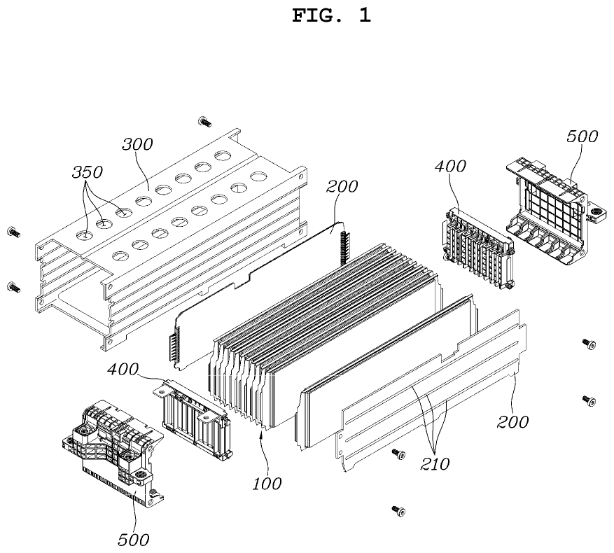

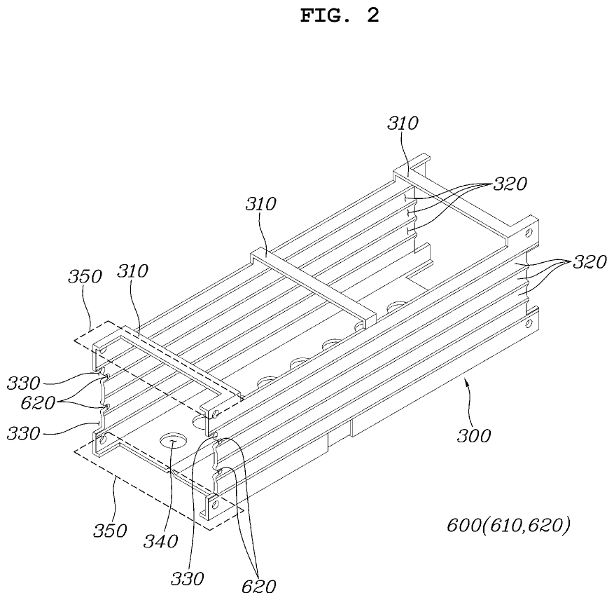

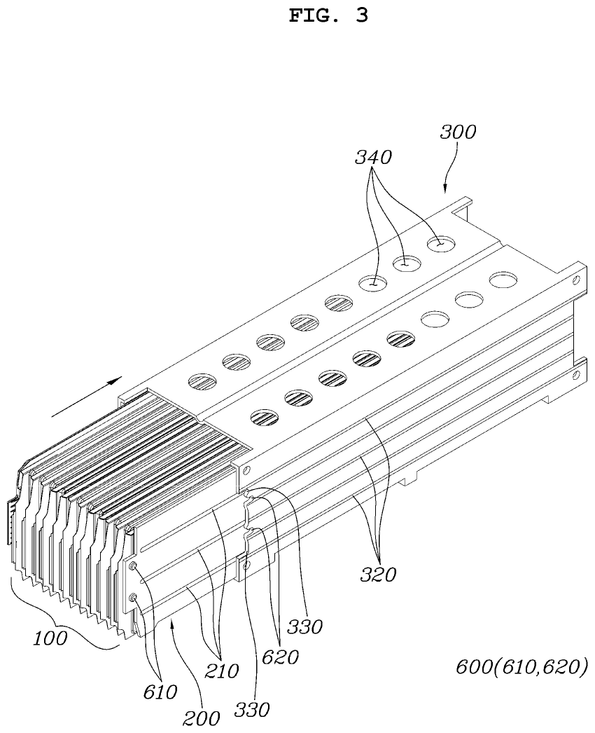

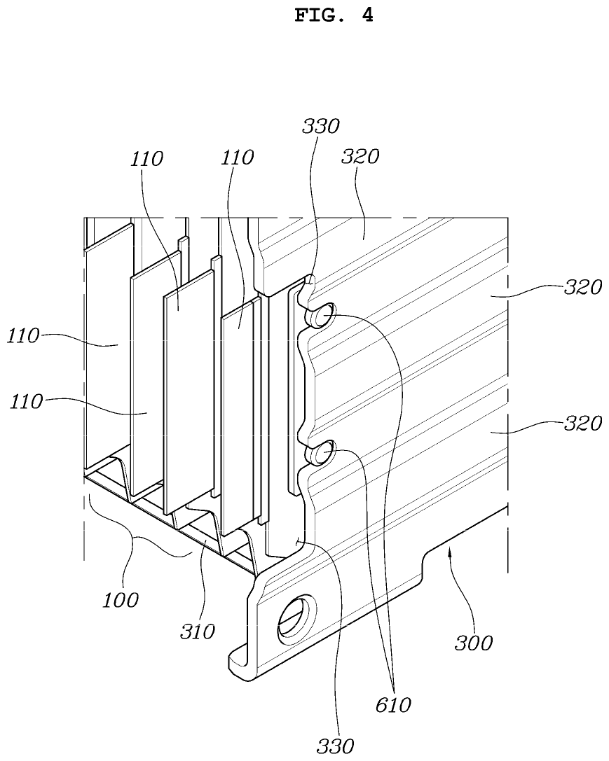

FIG. 1 is an exploded perspective view illustrating a battery module according to one form of the present disclosure, FIG. 2 is a bottom perspective view of a housing 300 according to another form of the, FIG. 3 is a view illustrating a housing 300, as well as a battery cell stack 100 and a pair of cell covers 200 are being inserted into the housing 300, according to one form of the present disclosure, and FIG. 4 is a view illustrating first protruding portions 610 and first recesses 620, into which the first protruding portions 610 are being fitted, according to another form of the present disclosure.

The battery module according to some exemplary forms of the present disclosure will be described with reference to FIGS. 1 to 4.

The battery module includes: the battery cell stack 100 comprised of a plurality of battery cells 110 stacked on each other in a first direction; the pair of cell covers 200 in surface contact with both side surfaces of the battery cell stack 100, with the both side surfaces of the battery cell stack 100 facing in the first direction; and the housing 300 covering the side surfaces of the cell covers 200 in the first direction and the top surfaces of the battery cell stack 100 and the cell covers 200, with the bottom side of the housing 300 being open.

Among the plurality of battery cells 110 of the battery cell stack 100, each battery cell 110 has an electrode on an end in a second direction perpendicular to the first direction. A battery cell pair formed by stacking two battery cells 110 having the same electrodes on each other is stacked in the first direction adjacently to another battery cell pair of two battery cells 110 having the other electrodes. In this manner, the battery cell stack 100 comprised of the plurality of battery cells 110 stacked on each other may be provided.

For example, after two battery cells 110 adjacent to the N pole are stacked, two battery cells 110 adjacent to the S pole may be stacked. Thereafter, two battery cells 110 adjacent to the N pole may be stacked again in the first direction.

The both side surfaces of the battery cell stack 100 in the first direction may be in surface contact with the cell covers 200 in order to be protected from external impact and impurities such as dust.

The battery cell stack 100 and the cell covers 200 are received in the housing 300. The housing 300 may be configured to house the cell covers 200 by covering the outer side surfaces and the top surfaces of the cell covers 200.

The housing 300 may be manufactured by extrusion molding into the shape of an angled pipe, followed by machining the bottom side thereof to have an open shape.

Both side walls of the housing 300 support the battery cell stack 100 and the cell covers 200 in the first direction. The top wall and the both side walls of the housing 300 serve to protect the battery cell stack 100 and the cell covers 200 from external impact.

In battery modules of the related art, covers protecting the both side surfaces and the top surface of the battery cell stack 100 are provided as separate members, which are in turn welded together. In contrast, according to the present disclosure, the housing 300 is provided integrally, and thus, the welding process is omitted. Accordingly, the manufacturing process of the present disclosure may be simplified than that of the battery module of the related art, thereby reducing costs.

The housing 300 may include connectors 310 on the bottom side thereof, the connectors 310 connecting the bottom portions of the both side walls of the housing 300 in the first direction.

The connectors 310 connecting the bottom portions of the both side walls of the housing 300 may be formed by cutting the bottom side of the housing 300 to be open, except for predetermined portions of the bottom side.

The connectors 310 may connect the both side walls of the housing 300 such that the both side walls of the housing 300 support the battery cell stack 100 and the cell covers 200 received in the housing 300.

In addition, the connectors 310 may support the battery cell stack 100 and the cell covers 200 received in the housing 300 so that none of the plurality of battery cells 110 of the battery cell stack 100 and the cell covers 200 moves out of the housing 300.

An insulating material may be applied to the bottom surface of the top wall and the top surface of the connector 310 of the housing 300.

In the housing 300 manufactured by extrusion molding and machining, in a position in which the battery cell stack 100 and the cell covers 200 are received in the housing 300, the bottom surface of the top wall of the housing 300 and the top surfaces of the connectors 310 may be in contact with the battery cell stack 100. To prevent external electric impact from being applied into the battery cells 110 and prevent the power of the battery cells 110 from leaking outward, the insulating material may be applied to the bottom surface of the top wall of the housing 300 and the top surfaces of the connectors 310.

Each of the cell covers 200 has guides 210 protruding from the outer surface thereof and extending in the longitudinal direction. Each of the both side walls of the housing 300 has grooves 320 extending in the longitudinal direction and conforming to the guides 210. The guides 210 may be inserted into the grooves 320 to guide the sliding of the battery cell stack 100 and the cell covers 200.

The battery cell stack 100 and the cell covers 200 in the stacked position may slide in the second direction from one end of the housing 300, with the one end of the housing 300 being in the second direction, and be inserted into the housing 300.

Here, each of the cell covers 200 may have the guides 210 protruding outward and extending in the second direction. The guides 210 may protrude in the first direction and linearly extend in the second direction.

In addition, the grooves 320 conforming to the guides 210 may be provided on the both side walls of the housing 300. The grooves 320 may be formed concurrently when the housing 300 is manufactured by extrusion molding.

Thus, when the battery cell stack 100 and the cell covers 200 are slid and inserted into the housing 300, the guides 210 may be inserted along the grooves 320, and thus, the direction of sliding may be guided.

The battery module may further include a fixing unit 600 provided on the cell covers 200 or the housing 300 to prevent the battery cell stack 100 and the cell covers 200 from moving within the housing 300.

The fixing unit 600 may be provided on the cell covers 200 or the housing 300, and when the cell covers 200 and the battery cell stack 100 in a stacked position are received in the housing 300, prevent from the cell covers 200 and the battery cell stack 100 from being dislodged from the housing 300.

The fixing unit 600 includes first protruding portions 610 protruding outward from one end of each of the cell covers 200 and first recesses 620 indented in the side walls of the housing 300, at positions corresponding to the first protruding portions 610. With the first protruding portions 610 being fitted into the first recesses 620, the battery cell stack 100 and the cell covers 200 may be fixed to the housing 300.

The outwardly-protruding first protruding portions 610 are formed on one end of each of the cell covers 200. The first protruding portions 610 may have the shape of protrusions. The first recesses 620 are formed in one end of each of the both walls of the housing 300, at positions corresponding to the first protruding portions 610. When the battery cell stack 100 and the cell covers 200 are inserted into the housing 300, the first protruding portions 610 may be fitted into the first recesses 620, thereby fixing the battery cell stack 100 and the cell covers 200, slid and inserted into the housing 300, within the housing 300.

Consequently, the battery cell stack 100 and the cell covers 200 may be fixed after having been inserted into the housing 300, thereby being prevented from being dislodged from the housing 300. Accordingly, the efficiency of mechanics may be improved.

In addition, the first protruding portions 610 and the first recesses 620 of the fixing unit 600 may have protrusion and recess structures to be simply manufactured, thereby improving the efficiency of manufacture and reducing costs.

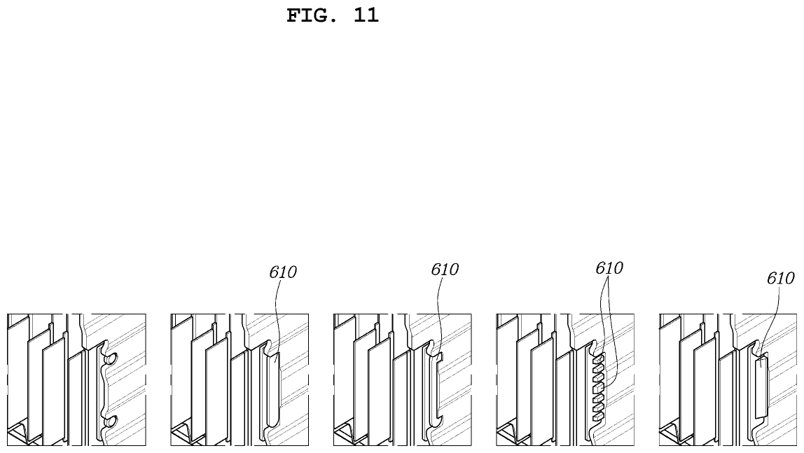

FIG. 11 is a view illustrating a variety of implementations of the fixing unit 600 according to another form of the present disclosure.

As illustrated in FIG. 11, the first protruding portions 610 of the fixing unit 600 may be manufactured in a variety of shapes protruding from the cell covers 200, and the first recesses 620 may be formed to conform to the first protruding portions 610. As the first protruding portions 610 are fitted into the first recesses 620, the cell covers 200 and the battery cell stack 100 comprised of the plurality of battery cells 110 stacked on each other may be fixed within the housing 300.

Through-holes 340 may be formed in the top wall of the housing 300.

The housing 300 may be manufactured such that a plurality of through-holes 340 is famed in the top wall thereof when machined after extrusion molding. The formation of the through-holes 340 in the housing 300 may reduce the overall weight of the housing 300 and dissipate heat generated by the plurality of battery cells 110.

The cell covers 200 may be made from an insulating material and may be manufactured to have a higher level of strength than the battery cells 110.

The entirety of the cell covers 200 may be made from an insulating material or only surface portions of the cell covers 200 in contact with the battery cell stack 100 may be made from an insulating material. Since the material of the cell covers 200 has a higher level of strength than that of the battery cells 110, the cell covers 200 may protect the battery cells 110 from impact applied in the first direction and protect the battery cells 110 from external electric power by blocking the external electric power applied to the battery cells 110.

The battery module may further include a pair of bus bar assemblies 400 located on both ends of the battery cell stack 100 in the second direction perpendicular to the first direction to join the electrodes of the plurality of battery cells 110 of the battery cell stack 100.

Both ends of each of plurality of battery cells 110 in the second direction have an electrode and a lead formed thereon. After the battery cell stack 100 is inserted into the housing 300, the bus bar assemblies 400 may be fitted to the battery cell stack 100 such that the electrodes of the battery cells 110 are fitted thereto in order to electrically connect the battery cells 110.

Each of the bus bar assemblies 400 includes second protrusions 410. The second protrusions 410 protrude outward from both ends of each of the bus bar assemblies 400, with the both ends of the bus bar assemblies 400 being in the first direction. Second recesses 340 are indented in the both side walls of the housing 300, at positions corresponding to the second protrusions 410. The second protrusions 410 may be fitted into the second recesses 340, thereby fixing the bus bar assemblies 400.

The second protrusions 410 protrude in the first direction from the both ends of the bus bar assemblies 400 in the first direction, and the second recesses 340 are indented in the both ends of the both side walls of the housing 300 so as to conform the second protrusions 410, such that the bus bar assemblies 400 are fixed after having been fitted to the battery cell stack 100 such that the electrodes of the battery cells 110 are fitted thereto. As the second protrusions 410 are fitted into the second recesses 340, the bus bar assemblies 400 may be fixed to the housing 300.

Each of the bus bar assemblies 400 includes a bus bar 420 having a plurality of slits. The electrodes of the plurality of battery cells 110 may be joined to the bus bar 420, with portions of the electrodes that have passed through the slits being bent.

As the electrodes of the battery cells 110 are inserted into the bus bars 420 each having the plurality of slits, the bus bar assemblies 400 may be connected to the plurality of battery cells 110.

The electrodes of the plurality of battery cells 110 that have passed through the slits of the bus bars 420 may be electrically connected by bending and welding or by any method other than welding.

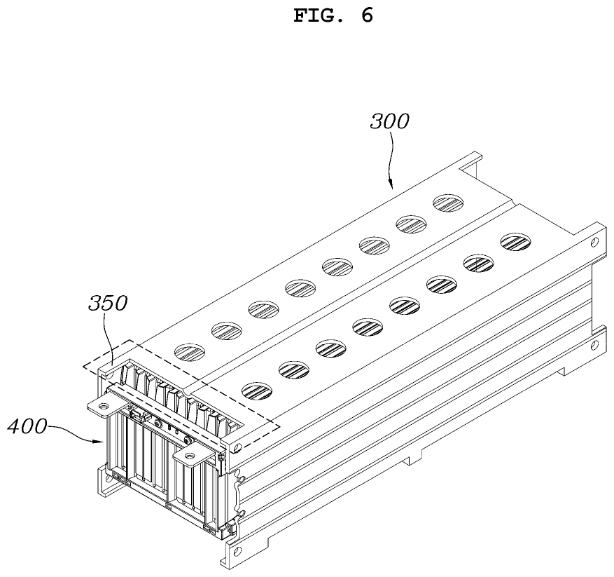

FIG. 6 is a view illustrating the housing 300, as well as the battery cell stack 100 and the cell covers 200 received in the housing 300, according to another form of the present disclosure.

Referring to FIG. 6, recesses 350 are formed in the top wall of the housing 300, indented in the second direction perpendicular to the first direction. When the electrodes of the plurality of battery cells 110 are joined to the bus bar 420, the stopper jigs S may be inserted through the recesses 350 to support the bus bar 420.

When the battery cells 100 are electrically connected to each other by welding, force may be applied to the bus bar assembly 400 in the second direction, thereby causing a risk that the central portion of the bus bar assemblies 400 may be bent in the second direction. To prevent this, the stopper jigs S supporting the bus bar assembly 400 may be inserted in the top-bottom direction from behind the bus bar assembly 400.

For the insertion of the stopper jigs S, the housing 300 may have the indented recesses 350 formed in portions through which the stopper jigs S are inserted.

In one form, the recesses 350 may be formed on the upper portion of the housing 300 as well as on the connectors 310 in the lower portion of the housing 300.

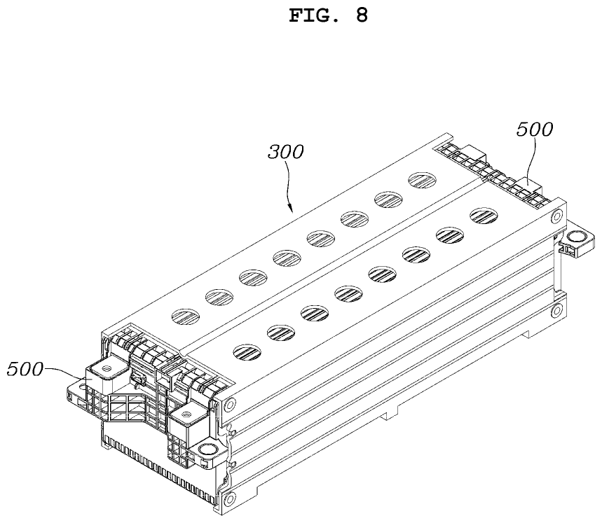

FIG. 8 is a perspective view illustrating the assembled battery module according to another form of the present disclosure.

Referring to FIG. 8, the battery module may further include a pair of housing covers 500 fastened to the both side surfaces of the housing 300 such that both ends of the housing 300 facing in the second direction perpendicular to the first direction are covered with the housing covers 500.

The housing covers 500 covering the both ends of the housing 300 in the second direction are coupled to the housing 300 in order to protect the both ends of the battery cell stack 100 in the second direction and the bus bar assemblies 400 from the outside after the bus bar assemblies 400 are coupled to the battery cell stack 100. The housing covers 500 may be fastened to the housing 300, with bolts passing through the both side walls of the housing 300.

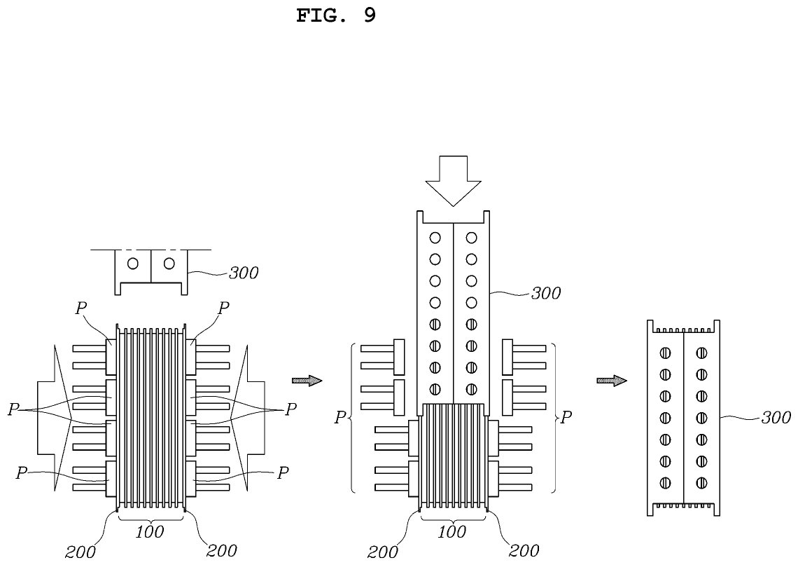

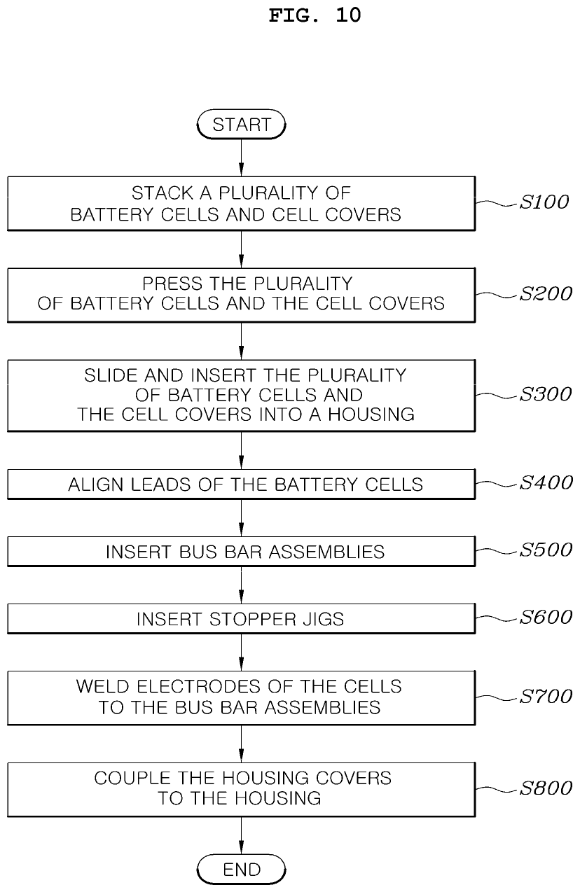

FIG. 9 is a view illustrating the sequence of insertion into the housing 300 in a method of manufacturing a battery module according to another form of the present disclosure, and FIG. 10 is a flowchart of the method of manufacturing a battery module according to one form of the present disclosure.

An exemplary form of the method of manufacturing a battery module according to the present disclosure will be described by referring to FIGS. 9 and 10.

The method of manufacturing a battery module includes: forming a battery cell stack 100 by stacking a plurality of battery cells 110 in a first direction and stacking the cell covers 200 on both side surfaces of the battery cell stack 100 (step S100); pressing the battery cell stack 100 and the cell covers 200 in the first direction using a plurality of pressing jigs P through both side surfaces of the cell covers 200 facing in the first direction, wherein the pressing jigs P are disposed in a second direction perpendicular to the first direction while facing each other in the first direction (step S200); and sliding and inserting the battery cell stack 100 and the cell covers 200 into the housing 300 while sequentially stopping the pressing of the pressing jigs P adjacent to the housing 300 from among the plurality of pressing jigs P (step S300).

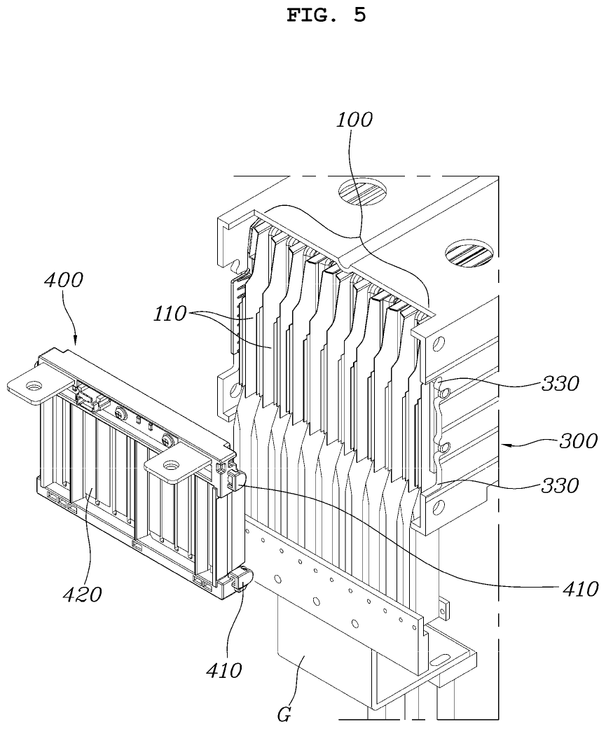

FIG. 5 is a view illustrating the battery cells 110 being aligned and the bus bar assemblies 400 being coupled to the battery cells 110 according to another form of the present disclosure.

Referring to FIG. 5, the method of manufacturing a battery module may further include: after the inserting step S300, aligning the leads of the plurality of battery cells 110 using an alignment guide G by inserting portions of the alignment guide G between the plurality of battery cells 110 (step S400); and inserting the bus bar assemblies 400 to join the electrodes of the plurality of battery cells 110 in a position in which the plurality of battery cells 110 is aligned (step S500).

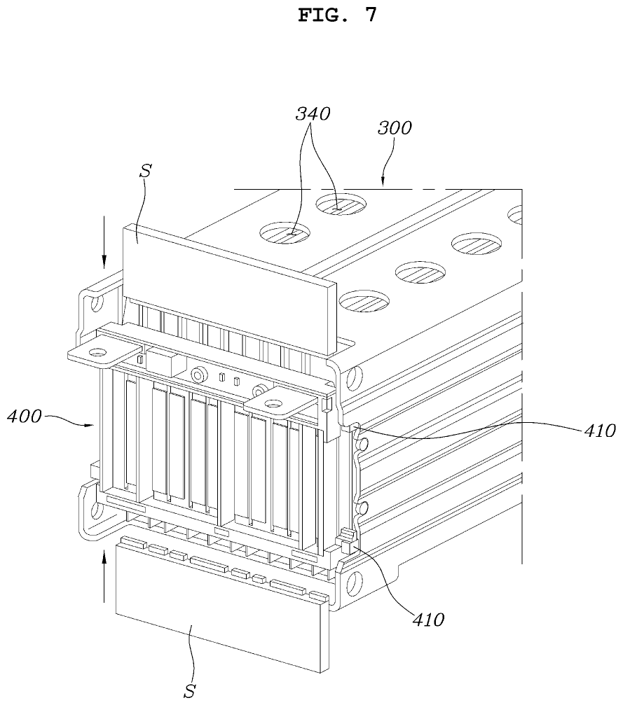

FIG. 7 is a view illustrating the insertion of the stopper jigs S supporting the bus bar assemblies 400 when the bus bar assemblies 400 are joined according to some forms of the present disclosure.

Referring to FIG. 7, the method of manufacturing a battery module may further include: after the step S500 of inserting the bus bar assemblies 400, inserting the stopper jigs S to fix the bus bar assemblies 400 (step S600); and welding the electrodes of the battery cells 110 to the bus bar assemblies 400 in a position in which the stopper jigs S are inserted (step S700).

The stopper jigs S support the bus bar assemblies during the welding of the battery cells 110 to the bus bar assemblies 400 and, after the welding, are removed in the opposite direction of the insertion.

The method of manufacturing a battery module according to the present disclosure may further include, after the welding step S700, coupling the housing covers 500 to the housing 300 such that both ends of the housing 300 facing in the second direction perpendicular to the first direction are covered with the housing covers 500 (step S800).

The housing covers may be fastened to the housing, with bolts passing through the both side walls of the housing.

Although the exemplary forms of the present disclosure have been described for illustrative purposes, those skilled in the art will appreciate that various modifications, additions, and substitutions are possible, without departing from the scope and spirit of the present disclosure.

What is claimed is:

1. A battery module comprising:
a battery cell stack including a plurality of battery cells stacked on each other in a first direction;
a pair of cell covers in surface contact with first and second side surfaces of the battery cell stack; and
a housing configured to cover the pair of cell covers in the first direction and top surfaces of the battery cell stack, wherein a bottom side of the housing being is open.

2. The battery module according to claim 1, wherein:
the housing comprises a connector arranged on the bottom side thereof, and
the connector is configured to connect bottom portions of side walls of the housing in the first direction.

3. The battery module according to claim 2, wherein the housing comprises an insulating material applied to a bottom surface of a top wall and a top surface of the connector.

4. The battery module according to claim 1, wherein:
each cell cover of the pair of cell covers comprises a guide protruding from an outer surface thereof and extending in a longitudinal direction,
side walls of the housing each include a groove extending in the longitudinal direction and conforming to the guide, and
the guide is inserted into the groove and configured to guide sliding of the battery cell stack and the pair of cell covers.

5. The battery module according to claim 1, further comprising a fixing unit provided on the pair of cell covers or the housing, the fixing unit configured to inhibit the battery cell stack and the pair of cell covers from moving within the housing.

6. The battery module according to claim 5, wherein the fixing unit comprises:
first protruding portions each protruding outward from one end of each cell cover of the pair of cell covers, and
first recesses indented in side walls of the housing, at positions corresponding to the first protruding portions, and
wherein the battery cell stack and the pair of cell covers are fixed to the housing when the first protruding portions are fitted into the first recesses.

7. The battery module according to claim 1, wherein the housing has a through-hole provided in a top wall thereof.

8. The battery module according to claim 1, wherein the pair of cell covers are made from an insulating material and a strength level of the pair of cell covers is greater than a strength level of the plurality of battery cells.

9. The battery module according to claim 1, further comprising a pair of housing covers fastened to side surfaces of the housing and configured to cover ends of the housing, wherein the ends of the housing are configured to face to each other in a second direction perpendicular to the first direction.

10. The battery module according to claim 1, further comprising a pair of bus bar assemblies located on ends of the battery cell stack in a second direction perpendicular to the first direction, and configured to join electrodes of the plurality of battery cells.

11. The battery module according to claim 10, wherein:
the pair of bus bar assemblies each include protrusions protruding outward from ends of each bus bar assembly of the pair of bus bar assemblies in the first direction,
recesses are indented in side walls of the housing at positions corresponding to the protrusions, and
the protrusions are fitted into the recesses, thereby fixing the pair of bus bar assemblies.

12. The battery module according to claim 10, wherein:
each bus bar assembly of the pair of bus bar assemblies comprises a bus bar having a plurality of slits,
the electrodes of the plurality of battery cells are joined to the bus bar, and
portions of the electrodes are configured to pass through the slits and bent.

13. The battery module according to claim 12, wherein:
recesses are formed in a top wall of the housing and indented in the second direction, and
when the electrodes of the plurality of battery cells are joined to the bus bar, stopper jigs are inserted through the recesses to support the bus bar.

14. A method of manufacturing a battery module where the battery module includes: a battery cell stack having a plurality of battery cells, a pair of cell covers, and a housing to cover the pair of cell covers, the method comprising:
stacking the plurality of battery cells in a first direction and covering side surfaces of the battery cell stack by the pair of cell covers;
pressing the battery cell stack and the pair of cell covers in the first direction using a plurality of pressing jigs through side surfaces of the pair of cell covers facing in the first direction, wherein the plurality of pressing jigs are disposed in a second direction perpendicular to the first direction while facing each other in the first direction; and
sliding and inserting the battery cell stack and the pair of cell covers into the housing while sequentially stopping pressing, among the plurality of pressing jigs, pressing jigs adjacent to the housing.

15. The method of manufacturing the battery module according to claim 14, further comprising:
after inserting the battery cell stack and the pair of cell covers into the housing, aligning leads of the plurality of battery cells using an alignment guide by inserting portions of the alignment guide between the plurality of battery cells; and
inserting bus bar assemblies to join electrodes of the plurality of battery cells in a position in which the plurality of battery cells is aligned.

16. The method of manufacturing the battery module according to claim 15, further comprising:
after inserting the bus bar assemblies, inserting stopper jigs to fix the bus bar assemblies; and
welding the electrodes of the plurality of battery cells to the bus bar assemblies in a position in which the stopper jigs are inserted.

17. The method of manufacturing the battery module according to claim 16, further comprising, after welding the electrodes of the plurality of battery cells, coupling housing covers to the housing such that ends of the housing facing in the second direction are covered with the housing covers.
